(19) United States
(12) Patent Application Publication
(10) Pub. No.: US 2008/0279294 A1
(43) Pub. Date: Nov. 13, 2008

(54) TDS-OFDMAA COMMUNICATION SYSTEM UPLINK FREQUENCY SYNCHRONIZATION

(75) Inventors: LIN YANG, FREMONT, CA (US); QIN LIU, FREMONT, CA (US)

Correspondence Address: FRANK F. TIAN, 331-4A THIRD AVENUE, LONG BEACH, NJ, 07740, US

(73) Assignee: LEGEND SILICONE CORP., FREMONT, CA (US)

(21) Appl. No.: 12/117,002

(22) Filed: May 8, 2008

Related U.S. Application Data
(60) Provisional application No. 60/916,564, filed on May 8, 2007.

(51) Int. Cl. H04J 11/00; H04L 27/28

(52) U.S. Cl. 375/260

(57) ABSTRACT

TDS-OFDM can be applied to uplink wireless communication multiple accesses through sub-channelization, which means that each user uses a portion of available bandwidth to achieve orthogonal multiple access, where the sub-carriers in each sub-band may be contiguous or distributed. Inside the bandwidth for each user, at least one random or known sequence is used as the guard interval between transmitted symbols, where the sequence is limited inside the sub-band.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

U.S. patent application Ser. No. ______ with attorney docket number LSFFT-056.

U.S. patent application Ser. No. ______ with attorney docket number LSFFT-058.

U.S. patent application Ser. No. ______ with attorney docket number LSFFT-059.

### REFERENCE TO RELATED APPLICATIONS

This application claims an invention which was disclosed in Provisional Application No. 60/916,564, filed May 8, 2007 entitled “TDS-OFDMA Communication System Uplink Frequency Synchronization”. The benefit under 35 USC §119(e) of the United States provisional application is hereby claimed, and the aforementioned application is hereby incorporated herein by reference.

### FIELD OF THE INVENTION

The present invention relates generally to an application in a TDS-OFDMA (Time Domain Synchronous—Orthogonal Frequency Division Multiple Access) system, more specifically the present invention relates to TDS-OFDMA Communication system uplink frequency synchronization.

### BACKGROUND

TDS-OFDM scheme is known. The scheme can be applied to uplink wireless communication multiple access through sub-channelization. It is desirable to utilize the guard interval between symbols in a TDS-OFDM system in which at least one random or known sequence is used as the guard interval between transmitted symbols. Furthermore, it is desirable to use the random or known sequence for uplink frequency synchronization.

### SUMMARY OF THE INVENTION

In TDS-OFDMA systems, at least one random or known sequence is used as the guard interval between transmitted symbols.

In TDS-OFDMA systems, wherein at least one random or known sequence is used as the guard interval between transmitted symbols in which the random or known sequence is further used for uplink frequency synchronization.

In a TDS-OFDM communications system for uplink wireless communication multiple accesses through sub-channelization, the system comprising: a plurality of users with each user using a portion of available time-frequency radio resources to achieve orthogonal multiple access; a plurality of available bandwidth, wherein the available bandwidth is divided into multiple sub-bands; at least one the sub-carrier in each sub-band. Inside the sub-band for each user, at least one guard sequence, being used as the guard interval between transmitted symbols.

In a TDS-OFDM communications system for uplink wireless communication multiple accesses through sub-channelization, a method comprising: providing a plurality of users with each user using a portion of available time-frequency radio resources to achieve orthogonal multiple access; providing a plurality of available bandwidth, wherein the available bandwidth is divided into multiple sub-bands; at least one the sub-carrier in each sub-band. Inside the sub-band for each user, at least one guard sequence, being used as the guard interval between transmitted symbols.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a TDS-OFDMA uplink multiple access system in accordance with some embodiments of the invention.

FIG. 1A is an example of a time-frequency allocation of the TDS-OFDMA uplink multiple access system of FIG. 1.

FIG. 1B is an example of a structure of the TDS-OFDMA uplink multiple access system of FIG. 1.

FIG. 2 is an example of a TDS-OFDM uplink initial access frequency synchronization in accordance with some embodiments of the invention.

FIG. 2A is an example of a flowchart depicting the TDS-OFDM uplink initial access frequency synchronization in accordance with some embodiments of the invention.

FIG. 3 is an example of a TDS-OFDM uplink periodic frequency synchronization in accordance with some embodiments of the invention.

FIG. 3A is an example of a flowchart depicting the TDS-OFDM uplink periodic frequency synchronization in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to calculating frequency offset using the guard sequence of the OFDM symbols in a TDS-OFDMA system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of calculating frequency offset using the guard sequence of the OFDM symbols in a TDS-OFDMA system described herein. The non-processor circuits may include, but are not limited to, a radio receiver, a radio transmitter, signal drivers, clock circuits, power source circuits, and user input devices. As such, these functions may be interpreted as steps of a method to perform calculating frequency offset using the guard sequence of the OFDM symbols in a TDS-OFDMA system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

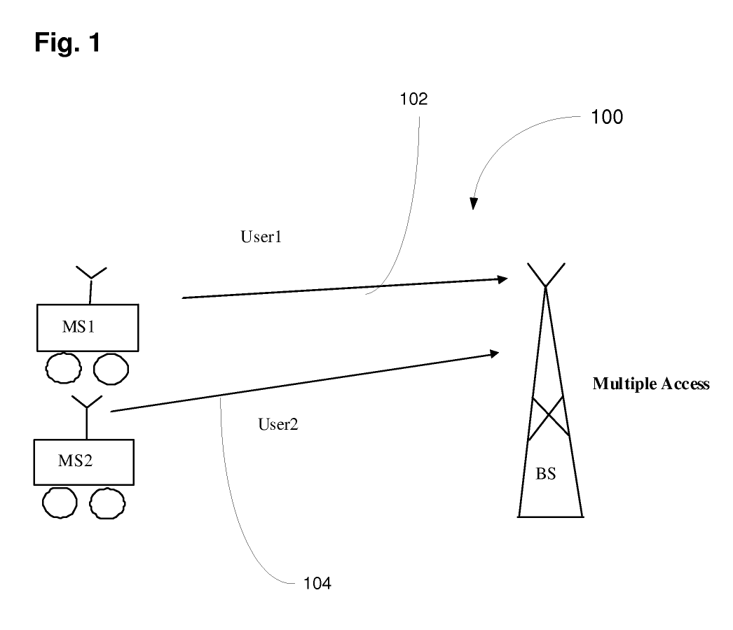

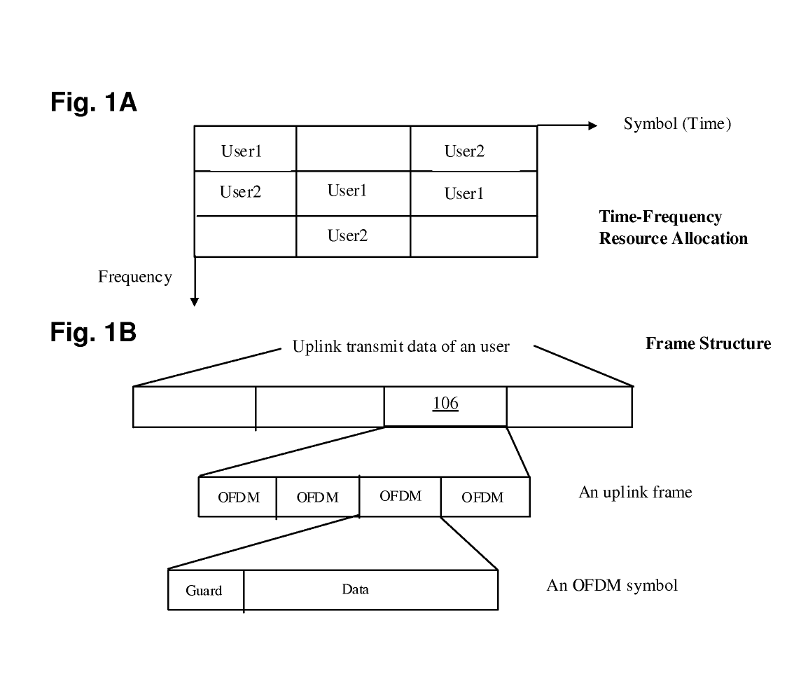

Referring to FIG. 1, a TDS-OFDM scheme 100 is applied to uplink wireless communication multiple accesses through sub-channelization. A plurality of users (only two, i.e. User1 and User2 are shown) associated with a plurality of mobile stations (only two, i.e. MS1 and MS2 are shown) are uplinked with a base station (BS) for multiple accesses.

Referring to FIG. 1A, a Time-Frequency resource allocation scheme is shown. Each user or each mobile station (MS) uses a portion of available bandwidth to achieve orthogonal multiple access. The sub-carriers in each sub-band may be contiguous or distributed. Users such as User1 and User2 may use same symbol time slot at frequencies orthogonal to each other. On the other hand, Users such as User1 and User2 may use same frequency at different symbol time.

Referring to FIG. 1B, a Frame Structure of a user or MS is shown. A sequence of uplink frames are transmitted by the user. Uplink frames comprises OFDM (orthogonal frequency division multiplexing) symbols. At least some OFDM symbols consist of a guard interval portion and a data portion. The guard interval may have pseudo noise (PN) sequences located therein. It is noted that the present invention contemplates using the PN sequence as guard intervals disclosed in U.S. Pat. No. 7,072,289 to Yang et al which is hereby incorporated herein by reference. However, other types of guard intervals are contemplated by the present invention as well. Inside the bandwidth for each user, at least one random or known sequence is used as the guard interval between transmitted symbols, where the sequence is limited inside the sub-band.

In both TDD (time division data multiplex) and FDD (frequency division multiplex) systems, it is required that the mobile station (MS) and the base station (BS) build carrier frequency synchronization. The guard sequence of the OFDM symbols of each user can be used to fulfill the function of carrier frequency synchronization. For the initial frequency synchronization, the BS may or may not assign some part of available time-frequency resource for initial access purposes. If the initial resource is assigned, then this assignment is known to all the users. The MS transmits the initial access signal (e.g. several OFDM symbols in a frame or a frame of OFDM symbols) at a random time using this default bandwidth or available bandwidth. The multiple accesses from different MSs may collide and then each collided MS needs to transmit the initial access signal at another random selected time based on some pre-selected algorithm.

The present invention relates to a TDS-OFDM communication system, more specifically relates to a TDS-OFDM communication system in uplink transmission.

Different users using different time-frequency resource allocations can be accommodated under the TDS-OFDM communication system. The available bandwidth is divided into multiple sub-bands, wherein in each sub-band the sub-carriers may be continuous or distributed. Inside each bandwidth, each user transmits uplink data using frame based structure. Each frame consists of multiple OFDM symbols. Each OFDM symbol consists of a time-domain guard sequence and OFDM data. The Guard sequence of each OFDM symbol is used to calculate the uplink frequency offset in a frequency domain. For initial access, the BS (base station) assigns default assigned time-frequency resources for an initial access. The MS (mobile station) transmits signals randomly or at a random time. If the BS receives the signal, it calculates the frequency offset using the guard sequence of OFDM symbols. The calculated frequency offset can be used for initial frequency synchronization or compensation.

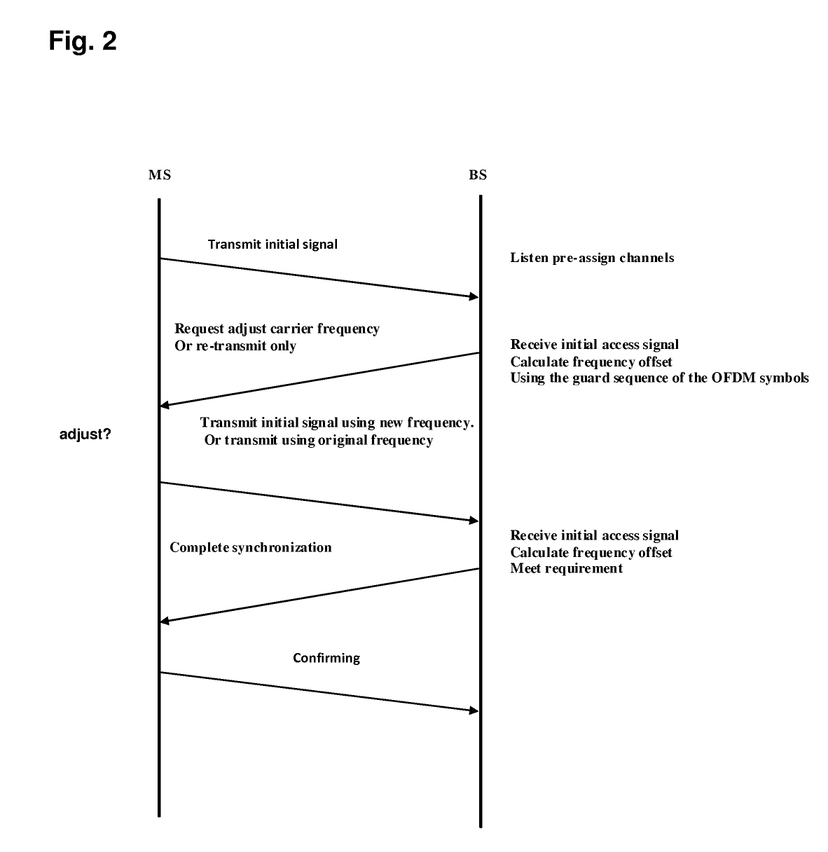

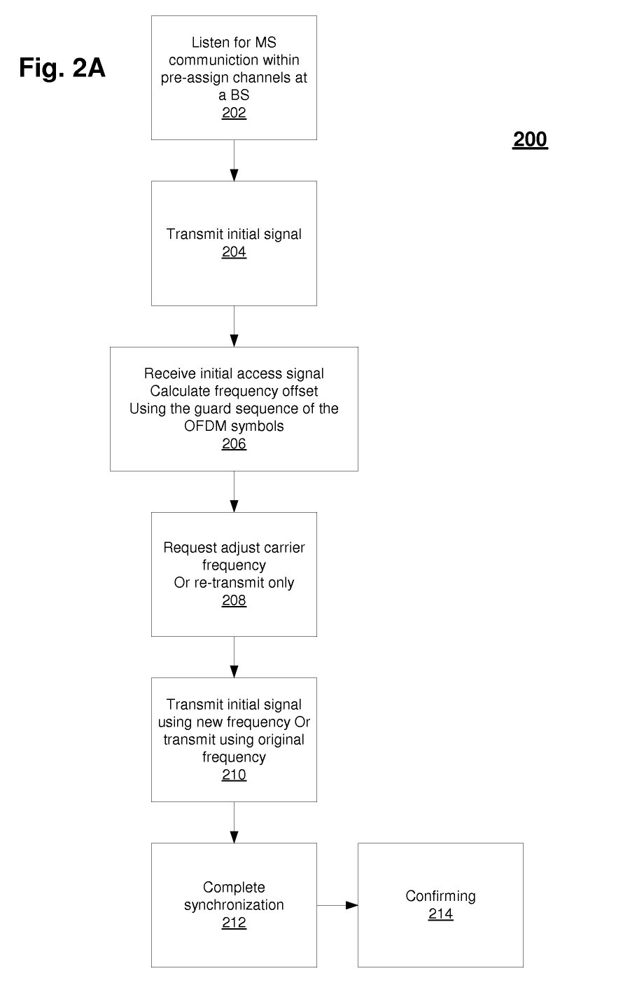

Referring to FIG. 2, an example of a TDS-OFDM uplink initial access frequency synchronization in accordance with some embodiments of the invention is shown. A MS transmits an initial signal and a BS listen in pre-assigned channels. Once the BS receives successfully a transmitted signal from the MS, it measures the frequency offset from this MS using the contents of the guard sequence of the OFDM symbol, then sends a request command to the MS to request the frequency adjustment or to compensate the local offset without sending the request command. If the MS receives the adjusting command, it may or may not adjust the frequency offset and transmits another frame of OFDM symbols again depending on the BS command. Once the BS confirms that the accepted frequency synchronization is achieved, it will send a confirmation command to the MS to complete the frequency synchronization. MS may send a confirming message or transmission to BS confirming the desired state for future transmissions.

Referring to FIG. 2A, a first flowchart 200 depicting the present invention is shown. Base station (BS) listens for a mobile station (MS) communication within a set of pre-assigned channels (Step 202). MS Transmits an initial signal to BS (Step 204). BS receives the initial access signal, calculates a frequency offset, by using the guard sequence of the OFDM symbols (Step 206). BS sends a Request for adjustment of carrier frequency, or merely maintaining transmission in the old or existing frequency only (Step 208). Receive initial access signal Calculate frequency offset Meet requirement (Step 210). Complete synchronization in that BS sends a signal to MS (Step 212). MS sends a confirming signal to BS confirming the completion of synchronization (Step 214).

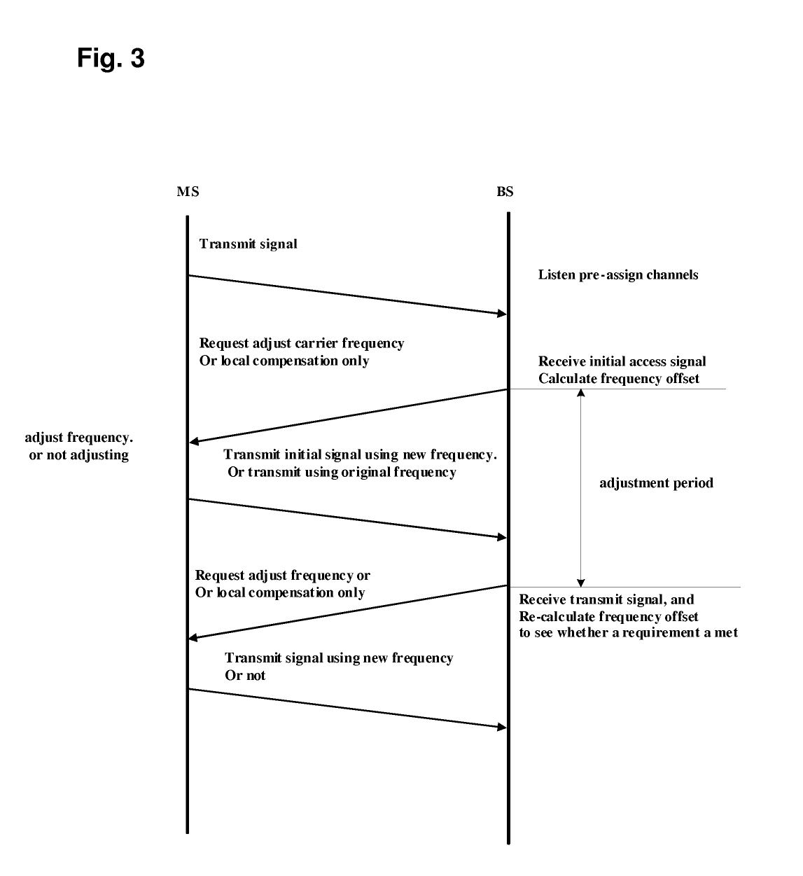

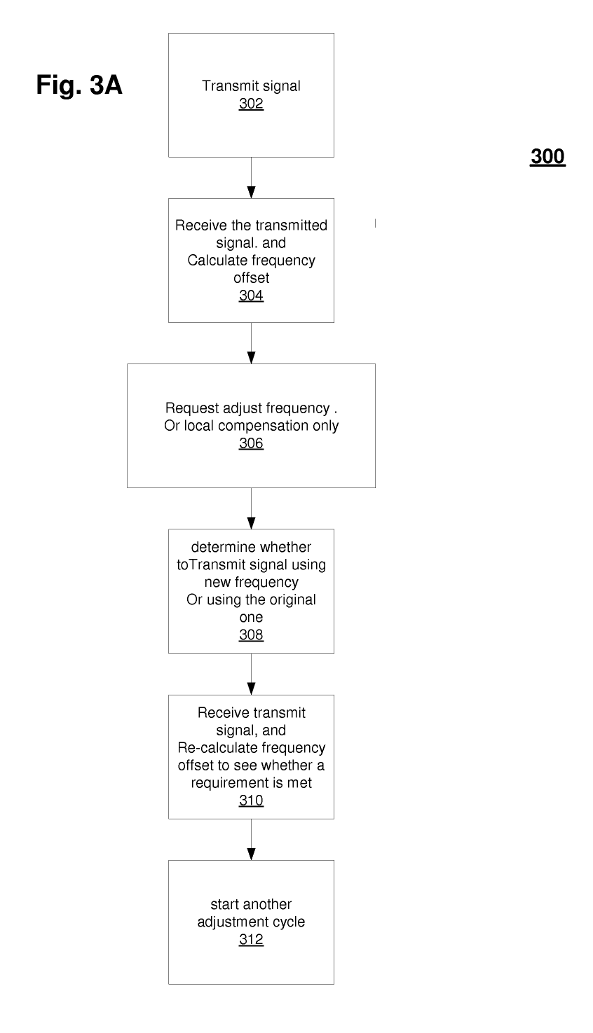

The users associated with their respective MS may move from one area to another. During the mobility, the MS frequency offset needs be measured periodically and the BS can use the guard sequence of the received signal of each user to calculate the frequency offset and sends the command to request the MS to adjust the carrier frequency or to do local frequency offset compensation, FIG. 3.

For mobility situations after initial access, the base station (BS) uses the guard sequence of OFDM symbols for calculating frequency offset using the received data. The calculated frequency offset can be used to maintain the carrier frequency synchronization or frequency compensation periodically.

Referring to FIG. 3, an example of a TDS-OFDM uplink periodic frequency synchronization during the mobility is shown. During the mobility, the MS frequency offset needs be measured periodically and the BS can use the guard sequence of the received signal of each user to calculate the frequency offset and sends the command to request the MS to adjust the carrier frequency or to do local frequency offset compensation. A MS transmits a signal to a BS. At this point, the adjustment period starts. The BS receives the transmitted signal, and calculates a frequency offset. The BS in turn requests the MS to adjust frequency, or alternatively to maintain or use local compensation only. The MS determines whether to adjust frequency or use local compensation only. A resultant frequency is determined, and the MS transmits a signal back to BS using the resultant frequency which may be a new frequency or the original frequency. At this point, the adjustment period ends. New adjustment periods may happen downwards along the time line.

Referring to FIG. 3A, a second flowchart 300 depicting the TDS-OFDM uplink periodic timing (frequency) synchronization is shown. Transmit a signal from MS to BS (Step 302). The BS receives the transmitted signal, and calculates a frequency offset (Step 304). In turn, BS requests MS to adjust frequency or maintain local compensation only (Step 306). MS determines whether to transmit a subsequent signal using new frequency, or using the original frequency (Step 308). Receive transmit signal, and BS re-calculates the frequency offset to see whether a requirement is met (Step 310). Another adjustment cycle may start down the timeline (Step 312).

It is advantageous over other systems in the use of guard sequence of the received signal of each user to calculate the frequency offset between symbols or data in such systems as TDS-OFDMA systems. The advantages include improved channel estimation time, improved synchronization time, and less need to insert more known values such as pilots in what would be used or reserved for data.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In a TDS-OFDM communications system for uplink wireless communication multiple accesses through sub-channelization, the system comprising:
a plurality of users with each user using a portion of available time-frequency radio resources to achieve orthogonal multiple access;
a plurality of available bandwidth, wherein the available bandwidth is divided into multiple sub-bands;
at least one the sub-carrier in each sub-band;
at least one guard sequence, being used as the guard interval between transmitted symbols.

2. The system of claim 1, wherein the sub-band is continuous.

3. The system of claim 1, wherein the sub-band is distributed.

4. The system of claim 1, wherein the guard sequence is a random sequence.

5. The system of claim 1, wherein the guard sequence is a known sequence.

6. The system of claim 1, wherein a base station receives a transmitted signal from a mobile station, and sends a request command to the mobile station to request a frequency adjustment or compensate with a local offset without sending the request command.

7. The system of claim 6, wherein the mobile station responds to the request command by sending OFDM symbols in an adjusted frequency.

8. In a TDS-OFDM communications system for uplink wireless communication multiple accesses through sub-channelization, a method comprising the steps of:
providing a plurality of users with each user using a portion of available time-frequency radio resources to achieve orthogonal multiple access;
providing a plurality of available bandwidth, wherein the available bandwidth is divided into multiple sub-bands;
providing at least one the sub-carrier in each sub-band;
providing at least one guard sequence, being used as the guard interval between transmitted symbols.

9. The method of claim 8, wherein the sub-band is continuous.

10. The method of claim 8, wherein the sub-band is distributed.

11. The method of claim 8, wherein the guard sequence is a random sequence.

12. The method of claim 8, wherein the guard sequence is a known sequence.

13. The method of claim 8, wherein a base station receives a transmitted signal from a mobile station, and sends a request command to the mobile station to request a frequency adjustment or compensate with a local offset without sending the request command.

14. The method of claim 13, wherein the mobile station responds to the request command by sending OFDM symbols in an adjusted frequency.
